(19) United States
(12) Patent Application Publication
(10) Pub. No.: US 2012/0223992 A1
(43) Pub. Date: Sep. 6, 2012

(54) INK JET PRINTING APPARATUS AND INK JET PRINTING METHOD

(75) Inventors: Shiki Hirata, Shiojiri-shi (JP); Tsuyoshi Sano, Shiojiri-shi (JP); Atsushi Denda, Chino-shi (JP)

(73) Assignee: SEIKO EPSON CORPORATION, Tokyo (JP)

(21) Appl. No.: 13/409,619

(22) Filed: Mar. 1, 2012

(30) Foreign Application Priority Data
Mar. 2, 2011 (JP) 2011-045566

(51) Int. Cl. B41J 2/21; B41J 29/38

(52) U.S. Cl. 347/14

(57) ABSTRACT

An ink jet printing apparatus prints an image using glitter ink with dispersed glitter pigment and clear ink which does not substantially include a color material. The ink jet printing apparatus has a first mode of ejecting substantially only the glitter ink to the printing medium to form the image by an ink jet method, and a second mode having a process of ejecting the glitter ink to the printing medium to form a first image by an ink jet method and a process of ejecting clear ink onto the first image by the ink jet method to form a second image, to form the image formed of the first image and the second image. A mode is selected from the first mode and the second mode to print the image on the printing medium.

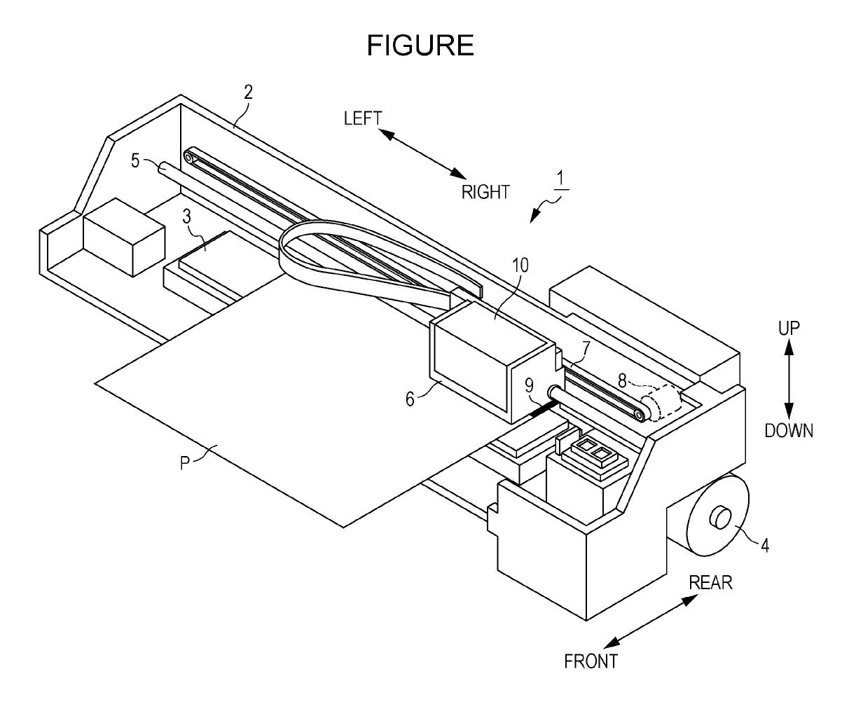

Priority is claimed under 35 U.S.C. §119 to Japanese Application No. 2011-045566 filed on Mar. 2, 2011, is hereby incorporated by reference in its entirety.

### BACKGROUND

1. Technical Field

The present invention relates to an ink jet printing apparatus, and an ink jet printing method.

2. Related Art

Recently, the demand for a print matter in which an image having photoluminescence is formed on a printing face has increased. As a method of forming the image having the photoluminescence, in the related art, for example, there are a gilding printing method of preparing a printing medium having a printing face with high flatness and impressing a metal foil thereon to print, a method of vacuum-depositing metal or the like on a plastic film with a smooth printing face, and a method of applying glitter pigment ink on a printing medium and further performing a press process thereon.

In addition, there is a method of ejecting ink (hereinafter, referred to as glitter ink) having a glitter pigment to perform printing according to an ink jet method (for example, see JP-A-2008-174712). According to the printing method using the glitter ink, there is an advantage where it is possible to simply form an image having photoluminescence, and it is possible to easily form various images.

The image (metallic image) printed using the glitter ink has metal gloss immediately after printing, but there is a problem in that the photoluminescence (gloss) decreases with the passage of time due to ozone gas or the like in the air. To prevent the decrease with the passage of time from occurring, there is a method of applying transparent ink (clear ink) to the surface to protect the metallic image.

When the transparent ink is applied to the surface of the metallic image, it is possible to suppress the decrease of photoluminescence with the passage of time. However, there is a problem in that a gloss degree of the metallic image is decreased as compared with the case of only the metallic image. For this reason, an ink jet printing apparatus capable of easily forming an image, which matches the needs, according to whether a high photoluminescence is necessary or durability (gas resistance) is necessary, is preferable.

### SUMMARY

An advantage of some aspects of the invention is to provide an ink jet printing apparatus and an ink jet printing method in which a user can appropriately select a mode of forming an image with excellent photoluminescence and a mode of forming an image having proper photoluminescence and excellent gas resistance.

According to an aspect of the invention, there is provided an ink jet printing apparatus which prints an image on a printing medium using glitter ink with glitter pigment dispersed therein and clear ink which does not substantially include a color material, wherein the ink jet printing apparatus has a first mode of ejecting substantially only the glitter ink to the printing medium to form the image by an ink jet method, and a second mode having a process of ejecting the glitter ink to the printing medium to form a first image by the ink jet method and a process of ejecting clear ink onto the first image by the ink jet method to form a second image, to form the image formed of the first image and the second image, and wherein a mode is selected from the first mode and the second mode to print the image on the printing medium.

With such a configuration, it is possible to provide the ink jet printing apparatus in which a user can appropriately select a mode of forming an image with excellent photoluminescence and a mode of forming an image with proper photoluminescence and excellent gas resistance.

In the ink jet printing apparatus according to the aspect of the invention, a third mode of ejecting a larger amount of glitter ink per unit area than that in the first mode to the printing medium to form the image by the ink jet method may be provided in addition to the first mode and the second mode, and a mode may be selected from the first mode, the second mode, and the third mode to print the image on the printing medium.

With such a configuration, it is possible to form the image at a low cost.

In the ink jet printing apparatus according to the aspect of the invention, a fourth mode having a process of ejecting the glitter ink to the printing medium to form a first image by the ink jet method and a process of ejecting clear ink onto the first image by the ink jet method to form a second image may be provided to form the image formed of the first image and the second image in addition to the first mode and the second mode, and in the fourth mode, a larger amount of glitter ink per unit area than that in the second mode to the printing medium may be ejected to form the image, and a mode may be selected from the first mode, the second mode, and the fourth mode to print the image on the printing medium.

With such a configuration, it is possible to broaden the selection of the image qualities desired by the user.

In the ink jet printing apparatus according to the aspect of the invention, a control unit that receives an instruction of a user may be further provided, and a mode may be selected from the first mode and the second mode on the basis of the instruction received by the control unit.

With such a configuration, it is possible to broaden the selection of the image qualities desired by the user.

In the ink jet printing apparatus according to the aspect of the invention, the glitter pigment included in the glitter ink may be silver particles.

With such a configuration, it is possible to form an image with excellent photoluminescence. Silver particles are a relatively expensive raw material, but it is possible to set the cost according to the purpose using the method of the invention.

In the ink jet printing apparatus according to the aspect of the invention, the amount of ejected glitter ink per unit area in the second mode may be smaller than the amount of ejected glitter ink per unit area in the first mode.

With such a configuration, it is possible to form the image at a low cost in the second mode as compared with the first mode.

In the ink jet printing apparatus according to the aspect of the invention, the glitter ink may contain water at 50 mass % or more.

With such a configuration, it is possible to reduce the cost of ink, and thus it is possible to significantly improve the effect based on the modes.

According to another aspect of the invention, there is provided an ink jet printing method of printing an image on a printing medium using glitter ink with dispersed glitter pigment and clear ink which does not substantially include a color material, wherein the ink jet printing method includes a first mode of ejecting substantially only the glitter ink to the printing medium to form the image, and a second mode having a process of ejecting the glitter ink to the printing medium to form a first image by an ink jet method and a process of ejecting clear ink onto the first image by the ink jet method to form a second image, to form the image formed of the first image and the second image, and wherein a mode is selected from the first mode and the second mode to print the image on the printing medium.

With such a configuration, it is possible to provide the ink jet printing method in which a user can appropriately select a mode of forming an image with excellent photoluminescence and a mode of forming an image with proper photoluminescence and excellent gas resistance.

### BRIEF DESCRIPTION OF THE DRAWINGS

The invention will be described with reference to the accompanying drawings, wherein like numbers reference like elements.

FIGURE is a perspective view illustrating an example of a schematic configuration of an ink jet printing apparatus of the invention.

### DESCRIPTION OF EXEMPLARY EMBODIMENTS

Hereinafter, preferred embodiments of the invention will be described in detail.

### Ink Jet Printing Apparatus

First, a preferred embodiment of an ink jet printing apparatus (liquid droplet ejecting apparatus) of the invention will be described.

FIGURE is a perspective view illustrating an example of a schematic configuration of the ink jet printing apparatus of the invention.

As shown in FIGURE, an ink jet printer 1 (hereinafter, referred to as a printer 1) as the ink jet printing apparatus has a frame 2. The frame 2 is provided with a platen 3, and a printing medium P is fed onto the platen 3 by driving a printing medium transport motor 4. The frame 2 is provided with a bar-shaped guide member 5 in parallel to the longitudinal direction of the platen 3.

A carriage 6 is supported to reciprocate in the axial direction of the guide member 5 by the guide member 5. The carriage 6 is connected to a carriage motor 8 through a timing belt 7 provided in the frame 2. The carriage 6 reciprocates along the guide member 5 by the driving of the carriage motor 8.

The carriage 6 is provided with a head 9, and is detachably provided with an ink cartridge 10 for supplying ink as a liquid to the head 9. The ink in the ink cartridge 10 is supplied from the ink cartridge 10 to the head 9 by driving a piezoelectric element (not shown) for the head 9, and is ejected from a plurality of nozzles formed on a nozzle formation face of the head 9 to the printing medium P fed onto the platen 3. Accordingly, it is possible to produce a print matter.

The printer 1 can eject glitter ink in which glitter pigment is dispersed, and clear ink which substantially does not include a color material.

The printer 1 has a first mode of ejecting substantially only the glitter ink to the printing medium P to form a metallic image, a second mode having a process of ejecting the glitter ink to the printing medium P to form a first image and a process of ejecting the clear ink onto the first image to form a second image to form an image formed of the first image and the second image, a third mode of ejecting a larger amount of glitter ink per unit area than that in the first mode to the printing medium P to form an image, and a fourth mode having a process of ejecting the glitter ink to the printing medium to form a first image and a process of ejecting the clear ink onto the first image to form the second image to form an image formed of the first image and the second image, in which a larger amount of glitter ink per unit area than that in the second mode is ejected to the printing medium to form an image, and a user can appropriately select a mode. The printer 1 is not particularly limited to providing the third mode and fourth mode, and may have only two kinds of modes such as the first mode and the second mode. In addition, “substantially only glitter ink” means that, for example, when ink other than the glitter ink is inevitably mixed, even though the other ink is mixed therein, it may be seen as equivalent to the glitter ink only without exhibiting a sufficient function.

However, the image (metallic image) printed using the glitter ink has metal gloss immediately after printing, but there is a problem in that the photoluminescence (gloss) is decreased with the passage of time by ozone gas in the air. To prevent such a decrease with the passage of time from occurring, the inventors found a method of applying transparent ink (clear ink) to the surface to protect the metallic image.

However, when the transparent ink is applied to the surface of the metallic image, it is possible to suppress the decrease of photoluminescence with the passage of time, but there is a problem in that a gloss degree of the metallic image is decreased as compared with the case of only the metallic image. For this reason, the inventors thought that an ink jet printing apparatus capable of easily forming an image matching the needs of whether high photoluminescence is necessary or high durability (gas resistance) is necessary is preferable hereafter.

The ink jet printing apparatus of the invention is characterized in that the first mode and the second mode described above are provided, and the user can appropriately select the mode.

The inventors obtained knowledge that the decrease of photoluminescence with the passage of time caused by ozone gas or the like is suppressed even when the amount of ejected glitter ink per unit area is increased. From the knowledge, it is preferable that the ink jet printing apparatus of the invention have a third mode of ejecting a larger amount of ejected glitter ink per unit area than that in the first mode to the printing medium P to form an image. Accordingly, it is possible to obtain a print matter in which the decrease of photoluminescence with the passage of time is further suppressed than the first mode, and thus it is possible to form an image further according to a demand of the user.

Meanwhile, it is preferable that the ink jet printing apparatus of the invention have a fourth mode having a process of ejecting the glitter ink to the printing medium to form a first image and a process of ejecting the clear ink onto the first image to form the second image to form an image formed of the first image and the second image, in which a larger amount of glitter ink per unit area than that in the second mode is ejected to the printing medium to form an image. Accordingly, it is possible to obtain a print matter in which the decrease of photoluminescence with the passage of time is further suppressed than the second mode, and thus it is possible to form an image further matching the needs of the user.

It is preferable that the amount of ejected glitter ink per unit area in the second mode be smaller than the amount of ejected glitter ink per unit area in the first mode. Accordingly, it is possible to form the image at a low cost in the second mode as compared with the first mode.

Specifically, it is preferable that the amount of ejected glitter ink per unit area in the second mode be around 10% to 50% smaller than the amount of ejected glitter ink per unit area in the first mode.

As described above, the third mode and the fourth mode are provided in addition to the first mode and the second mode, it is possible to broaden the selection of the image qualities desired by the user.

As the ejection method, thermal jet (bubble jet: registered trademark) method may be used. In addition, all the known methods may be used.

### Ink Jet Printing Method

Next, a preferred embodiment of an ink jet printing method of the invention will be described.

The ink jet printing method of the invention is a method of ejecting at least one of glitter ink with dispersed glitter pigment and clear ink which does not substantially include a color material to a printing medium by an ink jet method to print an image on the printing medium.

The ink jet printing method according to the embodiment is to form the image using the printer 1 described above, and has a first mode of ejecting the glitter ink to the printing medium to form an image, a second mode having a process of ejecting the glitter ink to the printing medium using the printer 1 to form a first image, and a process of further ejecting the clear ink onto the first image to form a second image to form an image formed of the first image and the second, and a third mode of ejecting a larger amount of ejected glitter ink per unit area than that in the first mode to the printing medium P to form an image, and a mode is appropriately selected from the modes according to desired image quality.

In the first mode, the image is formed using only the glitter ink, thus it is possible to form an image with excellent photoluminescence, and it is possible to form the image at a low cost as compared with the third mode.

In the second mode, the second image formed of the clear ink is overlapped onto the first image formed of the glitter ink, and thus it is possible to improve gas resistance (particularly, ozone gas resistance) of the formed image. The image formed in the second mode is not excellent in photoluminescence as compared with the image formed in the first mode, but has excellent gas resistance.

In the third mode, the amount of ejected glitter ink is larger than that in the first mode, and thus it is possible to suppress the decrease of photoluminescence with the passage of time.

As described above, the first mode and the second mode are provided, and can be appropriately selected. Accordingly, the user may select the first mode when the image with high initial photoluminescence is satisfactory and the deterioration with the passage of time does not matter, and the user may select the second mode when an image which has proper photoluminescence and is stable with the passage of time is desired. Therefore, it is possible to easily form the image matching the respective needs.

As described above, when the fourth mode is provided, the amount of ejected glitter ink is increased lager than that in the second mode even at a higher cost than that in the second mode, and thus it is possible to suppress the decrease of photoluminescence with the passage of time.

### Printing Apparatus

Next, a printing apparatus having the first to fourth modes will be described. However, the first mode and the second mode are essential in the invention, but the third mode and the fourth mode may be arbitrary. The printing apparatus may automatically select the first mode to the fourth mode on the basis of an image input from a host device, but each mode may be selected on the basis of an instruction of the user as follows.

When the printing apparatus has a control unit that controls the modes on the basis of the instruction of the user, the control unit has a display unit that displays a screen on which the user can input the instruction. A specific example of the control unit is not particularly limited, but may be a CPU and an ASIC, and the control unit may be configured by a plurality of control chips. The control unit may directly display a user interface on the screen provided in the printing apparatus, and may display it on a screen of the host device such as a personal computer.

The control unit is designed to control the first to fourth modes on the basis of the instruction of the user input through the user interface. A specific example of the user interface is not particularly limited, but it is conceivable to display a menu such as “high gloss, long term preservation (fourth mode)”, “high gloss, normal preservation (third mode)”, “normal gloss, long term preservation (second mode)”, and “normal gloss, normal preservation (first mode)” for the user to select. In addition, it is conceivable that conditions of a print image such as a preservation period (for example, six months) desired by the user and a gloss degree (for example, 60° gloss degree is 300) desired by the user are input, and the printing apparatus automatically select a mode according to the conditions.

### Printing Medium

The printing medium is not particularly limited, for example, various kinds of paper, cloth, film, and sheets.

### Glitter Ink

The glitter ink contains a glitter pigment. As the glitter pigment contained in the glitter ink, an arbitrary pigment may be used in the range in which liquid droplets of the ink can be ejected according to the ink jet printing method. The glitter pigment has a function of applying photoluminescence when the glitter ink is attached onto a layer of resin ink, and the photoluminescence may be applied to the attachment material. As such a glitter pigment, a pearl pigment and metal particles may be used. A representative example of the pearl pigment, a pigment having pearl gloss or interference gloss such as titanium dioxide coated mica, argentine, and bismuth oxychloride may be used. As the metal particles, particles such as aluminum, silver, gold, platinum, nickel, chrome, tin, zinc, indium, titan, and copper may be used, and at least one kind selected from a single body thereof or alloy thereof and a mixture thereof may be used.

The glitter pigment used in the embodiment is preferably silver particles from the viewpoint of height of the gloss degree (photoluminescence). The silver particles are a relatively expensive raw material, but it is possible to set the cost according to purpose using the method of the invention. The standard for the gloss degree may be based on JIS Z 8741 (1997).

Hereinafter, a specific example of glitter ink will be described with reference to silver ink.

### (1) Silver Particles

As described above, the silver ink according to the embodiment contains silver particles. As described above, the silver ink includes the silver particles (particularly, including the silver particles with wax satisfying a predetermined condition), and thus it is possible to form an image with excellent metal gloss. Since the silver is metal with a high white color degree among various kinds of metal, it is possible express various metal colors such as gold and copper through overlapping with other colors of ink.

The average particle diameter of silver particles is preferably 3 nm or more and 100 nm or less, and more preferably 20 nm or more and 65 nm or less. Accordingly, gloss feeling (photoluminescence) and friction resistance of the image formed using the silver ink can be particularly excellent. Ejection stability (landing position precision, stability of the amount of ejection, and the like) of the ink based on the ink jet method can be particularly excellent, and thus it is possible to more reliably form an image with a desired image quality for a long period. In the specification, the “average particle diameter” indicates an average particle diameter based on volume as long as there is no particular restriction. The average particle diameter may be measured by a granularity distribution measuring device based on a laser diffraction scattering method as a measurement principle. As the laser diffractive type granularity distribution measuring device, for example, a granularity distributor (for example, “Micro-Track UPA” manufactured by Nikkiso Co., Ltd.) based on a dynamic light scattering method as a measurement principle may be used.

The content of silver particles in the silver ink is preferably 0.5 mass % or more and 30 mass % or less, and more preferably 5.0 mass % or more and 15 mass % or less. Accordingly, the ejection stability of ink based on the ink jet method and the preservation stability of ink can be particularly excellent. In a wide range in which density (content per unit area) of silver particles on the printing medium considered as a print matter is low and high, it is possible to realize a satisfactory image quality and friction resistance.

The silver particles may be prepared by any method, for example, a solution including silver ions is prepared and the silver ions are reduced, thereby preferably forming the silver particles.

### (2) Resin

The glitter ink may contain a resin, and thus the fixing property and friction resistance are improved by containing the resin. The resin may be polyacrylate, polymethacrylate, polymethacrylate ester, polyethylacrylate, styrene-butadiene copolymer, polybutadiene, acrylonitrile-butadiene copolymer, chloroprene copolymer, fluorine resin, vinylidene fluoride, polyolefin resin, cellulose, styrene-acrylate copolymer, styrene-methacrylate copolymer, polystyrene, styrene-acryl amide copolymer, polyisobutyl acrylate, polyacrylonitrile, polyvinyl acetate, polyvinyl acetal, polyamide, rosin-based resin, polyethylene, polycarbonate, vinylidene chloride resin, cellulose-based resin such as cellulose acetate butylate, vinyl acetate resin, ethylene-vinyl acetate copolymer, vinyl acetate-acryl copolymer, vinyl chloride resin, polyurethane, rosin ester, and the like, but is not limited thereto.

### (3) Water

The glitter ink according to the invention may be aqueous ink including water at 50 mass % or more, and may be non-aqueous ink in which the content of water is less than 50 mass %.

In the case of the aqueous ink including water at 50 mass % or more, a dispersion property of silver particles is improved, and it is possible to effectively arrange the silver particles on the surface of the formed image. As a result, it is possible to more effectively print (form) the image with excellent photoluminescence and gas resistance. In addition, it is possible to lower the cost of ink, and the effect based on the modes can be significant.

When the ink contains water, it mainly serves as a dispersion medium which disperses the silver particles. Since the ink includes water, dispersion stability of the silver particles can be excellent, it is possible to rapidly perform drying on the printing medium to which the ink is applied while preventing the ink from being involuntarily dried (vaporization of dispersion medium) in the vicinity of the nozzles of the ink jet printing apparatus. Accordingly, it is possible to preferably perform the high-speed printing of a desired image for a long period. When the ink contains water, the content of the water is not particularly limited, but it is preferably 20 mass % or more and 80 mass % or less, and more preferably 25 mass % or more and 70 mass % or less.

### (4) Multivalent Alcohol

The glitter ink according to the invention preferably contains multivalent alcohol. When the ink according to the embodiment is applied to the ink jet printing apparatus, the multivalent alcohol suppresses the drying of the ink, and it is possible to prevent clogging caused by the ink from occurring at the ink jet printing head part.

The multivalent alcohol may be, for example, ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, trimethylolpropane, 1,2-butanediol, 1,2-pentanediol, 1,2-hexanediol, 1,6-hexanediol, 1,2-heptanediol, and 1,2-octanediol. Among them, alkanediol with carbon number of 4 to 8 is preferable, and alkanediol with carbon number of 6 to 8 is more preferable. Accordingly, permeability to the printing medium can be particularly high. The content of multivalent alcohol in ink is not particularly limited, but is preferably 0.1 mass % or more and 20 mass % or less, and more preferably 0.5 mass % or more and 10 mass % or less.

Among the multivalent alcohols, the ink preferably includes 1,2-hexanediol and trimethylolpropane. Accordingly, dispersion stability of silver particles in ink can be particularly excellent, preservation stability of ink can be particularly excellent, and ejection stability of ink can be particularly excellent.

### (5) Glycol Ether

The glitter ink according to the invention preferably contains glycol ether. By containing glycol ether, wettability of the printing medium or the like to a target printing face is improved, and thus it is possible to improve permeability of ink.

The glycol ether may be lower alkyl ether of mutilvalent alcohol such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylen glycol monomethyl ether, triethylen glycol monobutyl ether, and tripropylene glycol monomethyl ether. Among them, when triethylen glycol monobutyl ether is used, it is possible to obtain satisfactory printing image quality. The content of the glycol ether in ink is not particularly limited, but is preferably 0.2 mass % or more and 20 mass % or less, and more preferably 0.3 mass % or more and 10 mass % or less.

### (6) Surfactant

The glitter ink according to the invention preferably contains acethylene glycol surfactant or polysiloxane surfactant. The acethylene glycol surfactant or polysiloxane surfactant improves wettability of the printing medium or the like to a target printing face, and thus it is possible to improve permeability of ink.

The acethylene glycol surfactant may be, for example, 2,4,7,9-tetramethyl-5-desine-4,7-diol, 3,6-dimethyl-4-octine-3,6-diol, 3,5-dimethyl-1-hexine-3-ol, and 2,4-dimethyl-5-hexine-3-ol. As the acethylene glycol surfactant, a commercially available may be used, for example, Orfin E1010, STG, Y (manufactured by Nissin Chemical Industries, Ltd.) and Surfynol 104, 82, 465, 485, TG (manufactured by Air Products and Chemicals Inc.).

As the polysiloxane surfactant, a commercially available may be used, for example, BYK-347 and BYK-348 (manufactured by BYK-Chemie Japan Co., Ltd.).

The ink according to the invention may contain another surfactant such as a negative-ionic surfactant, a non-ionic surfactant, and a dual surfactant.

The content of the surfactant in ink is not particularly limited, but is preferably 0.01 mass % or more and 5.0 mass % or less, and more preferably 0.1 mass % or more and 1.5 mass % or less.

### (7) Other Components

The glitter ink according to the invention may include components other than the components described above (other components). As such components, for example, a pH adjustment agent, penetrant, organic binder, urea compound, drying suppressing agent such as alkanolamine (triethanol amine and the like), and thiourea may be used.

### Clear Ink

The clear ink is ink which does not substantially include a color material. The “does not substantially include a color material” means that, for example, the content of the color material in the clear ink is less than 0.1 mass %, preferably less than 0.05 mass %, and more preferably less than 0.01 mass %.

As long as the clear ink does not substantially include a color material and a layer formed by the clear ink has light permeability, a composition thereof is not particularly limited, for example, and may be configured by resin, water, multivalent alcohol, glycol ether, surfactant, and the like, which are components other than the silver particles described in the paragraph of the glitter ink.

The resin content of the ink is preferably 0.1 mass % or more and 20 mass % or less, and more preferably 0.5 mass % or more and 10 mass % or less. When the clear ink contains resin, the clear ink becomes ink applying superior gas resistance to an image.

In the embodiment, the image is formed by the glitter ink and the clear ink, but color ink including a color material may be used.

An image is formed on the metallic image formed by the glitter ink by the color ink, and thus it is possible to form a color metallic image. In addition, it is possible to further broaden the selection of image quality of the user.

In the second mode, the color image may be formed between the metallic image and the clear image formed by the clear ink, and the color image may be formed on the clear image.

As the color ink, for example, the following ink may be used.

### Color Ink

The color ink includes a color material. The color ink may be ink such as cyan, magenta, yellow, light cyan, light magenta, dark yellow, red, green, blue, orange, and violet, black ink, light black ink, and the like.

The color material may be pigment and dye, and color materials which can be used in the normal ink may be used without particular limit.

The pigment which can be used in the embodiment is not particularly limited, and various kinds of known pigments may be used.

Yellow organic pigment may be C.I. pigment yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, and the like.

Magenta organic pigment may be C.I. pigment red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C.I. pigment violet 19, 23, 32, 33, 36, 38, 43, 50, and the like.

Cyan organic pigment may be C.I. pigment blue 1, 2, 3, 15, 15:1, 15:2, 15:3, 15:4, 15:6, 15:34, 16, 18, 22, 25, 60, 65, 66, and C.I. vat blue 4, 60, and the like.

Organic pigment other than magenta, cyan, and yellow may be, for example, C.I. pigment green 7, 10, C.I. pigment brown 3, 5, 25, 26, C.I. pigment orange 2, 5, 7, 13, 14, 15, 16, 24, 34, 36, 38, 40, 43, 63, and the like.

The average particle diameter of pigment is preferably in the range of 10 nm or more and 200 nm or less, and more preferably 50 nm or more and 150 nm or less. The content of the pigment in the embodiment is preferably in the range of 1 mass % or more and 25 mass % or less, and more preferably 3 mass % or more and 20 mass % or less.

As dye which can be used in the embodiment, there are, for example, acridine dye, aniline dye, anthraquinone dye, azine dye, azomethine dye, benzoic and naphthoquinone dye, indigoid dye, indophenol dye, indoaniline dye, indamine dye, leuco dye, naphthalimide dye, nigrosine dye, indulines dye, nitro and nitroso dye, oxazine and dioxazine dye, oxide dye, phthalocyanine dye, polymethine dye, quinophthalone dye, sulfide dye, tri- and diacrylicmethane dye, thiazine dye, thiazole dye, xanthene dye, and cyanine dye.

The specific yellow dye may be C.I. acid yellow 1, 3, 11, 17, 19, 23, 25, 29, 36, 38, 40, 42, 44, 49, 59, 61, 70, 72, 75, 76, 78, 79, 98, 99, 110, 111, 127, 131, 135, 142, 162, 164, 165, C.I. direct yellow 1, 8, 11, 12, 24, 26, 27, 33, 39, 44, 50, 58, 85, 86, 87, 88, 89, 98, 110, 132, 142, 144, C.I. reactive yellow 1, 2, 3, 4, 6, 7, 11, 12, 13, 14, 15, 16, 17, 18, 22, 23, 24, 25, 26, 27, 37, 42, C.I. food yellow 3, 4, C.I. solvent yellow 15, 19, 21, 30, 109, and the like.

The specific magenta dye may be C.I. acid red 1, 6, 8, 9, 13, 14, 18, 26, 27, 32, 35, 37, 42, 51, 52, 57, 75, 77, 80, 82, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 209, 211, 215, 219, 249, 252, 254, 262, 265, 274, 282, 289, 303, 317, 320, 321, 322, C.I. direct red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, 231, C.I. reactive red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, 64, C.I. solvent red 1, C.I. food red 7, 9, 14, and the like.

The specific cyan dye may be, for example, C.I. acid blue 1, 7, 9, 15, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 182, 183, 184, 187, 192, 199, 203, 204, 205, 229, 234, 236, 249, C.I. direct blue 1, 2, 6, 15, 22, 25, 41, 71, 76, 77, 78, 80, 86, 87, 90, 98, 106, 108, 120, 123, 158, 160, 163, 165, 168, 192, 193, 194, 195, 196, 199, 200, 201, 202, 203, 207, 225, 226, 236, 237, 246, 248, 249, C.I. reactive blue 1, 2, 3, 4, 5, 7, 8, 9, 13, 14, 15, 17, 18, 19, 20, 21, 25, 26, 27, 28, 29, 31, 32, 33, 34, 37, 38, 39, 40, 41, 43, 44, 46, C.I. solvent vat blue 1, 5, 41, C.I. vat blue 4, 29, 60, C.I. food blue 1, 2, C.I. basic blue 9, 25, 28, 29, 44, and the like.

The other specific dye of the color system may be, for example, C.I. acid green 7, 12, 25, 27, 35, 36, 40, 43, 44, 65, 79, C.I. direct green 1, 6, 8, 26, 28, 30, 31, 37, 59, 63, 64, C.I. reactive green 6, 7, C.I. acid violet 15, 43, 66, 78, 106, C.I. direct violet 2, 48, 63, 90, C.I. reactive violet 1, 5, 9, 10, and the like.

As such dyes, a plurality of dyes may be selected and used from the group of dyes of each color system.

The content of dye in the embodiment is preferably in the range of 1 mass % or more and 25 mass % or less, and more preferably 3 mass % or more and 20 mass % or less.

The color ink preferably includes a resin component. Accordingly, it is possible to further improve adhesion of the second image to the printing medium.

The resin component may be polyacrylate, polymethacrylate, polymethacrylate ester, polyethylacrylate, styrene-butadiene copolymer, polybutadiene, acrylonitrile-butadiene copolymer, chloroprene copolymer, fluorine resin, vinylidene fluoride, polyolefin resin, cellulose, styrene-acrylate copolymer, styrene-methacrylate copolymer, polystyrene, styrene-acryl amide copolymer, polyisobutyl acrylate, polyacrylonitrile, polyvinyl acetate, polyvinyl acetal, polyamide, rosin-based resin, polyethylene, polycarbonate, vinylidene chloride resin, cellulose-based resin such as cellulose acetate butylate, vinyl acetate resin, ethylene-vinyl acetate copolymer, vinyl acetate-acryl copolymer, vinyl chloride resin, polyurethane, rosin ester, and the like, but is not limited thereto.

The content of the resin in color ink is preferably 0.1 mass % or more and 10 mass % or less, and more preferably 0.5 mass % or more and 5 mass % or less. Accordingly, it is possible to more effectively form the second image with an excellent coloring property. Since the ink contains the resin component, it becomes ink with superior gas resistance.

The invention has been described above on the basis of the preferred embodiment, but the invention is not limited thereto.

### EXAMPLES

Next, a specific example of the invention will be described.

### [1] Preparation of Glitter Ink

Polyvinylpyrrolidone (PVP, weight average molecular weight 10000) was heated at 70° for 15 hours, and then was cooled to room temperature. The PVP of 1000 g was added to an ethylene glycol solution of 500 ml, and the PVP solution was adjusted. The ethylene glycol of 500 ml was put in the other container, silver nitrate of 128 g was added thereto, stirring was performed by a stirrer, and a silver nitrate solution was adjusted. The silver nitrate solution was added while stirring the PVP solution at 120° C. using an overhead mixer, and it was heated for about 80 minutes to progress a reaction. Thereafter, it was cooled to room temperature. Centrifugal separation was performed on the obtained solution at 2200 rpm for 10 minutes by a centrifugal separator. Thereafter, the separated silver particles were removed, and were added to an ethanol solution of 500 ml to remove the extra PVP. The centrifugal separation was further performed, and the silver particles were taken out. The removed silver particles were dried at 35° C. at 1.3 Pa by a vacuum dryer.

1,2-hexanediol of 3 mass %, triethanol amine of 0.3 mass %, trimethylolpropane of 15 mass %, non-ionic surfactant (Orfin (R) E1010 manufactured by Nissin Chemical Industries, Ltd.) of 1 mass %, and ion-exchange water for adjusting concentration were added to the silver particles at 10 mass % produced as described above, to produce glitter ink.

### [2] Adjustment of Clear Ink

Adjustment was performed to be 1,2-hexanediol of 3 mass %, trimethylolpropane at 15 mass %, resin (Joncryl (R) 62 (manufactured by BASF, Co., Ltd.)) at 10 mass %, non-ionic surfactant (Orfin (R) E1010) at 1 mass %, pH adjustment agent (triethanol amine) at 0.3 mass %, and the remainder of ion-exchange water.

### [3] Formation of Print Matter

First, a dedicated cartridge of an ink jet printer (“PX-G930” manufactured by Seiko Epson Co., Ltd.) was filled with the glitter ink and the clear ink. The first mode of ejecting glitter ink to form a metallic image, and the second mode having a process of ejecting glitter ink to form a first image and a process of ejecting clear ink onto the first image to form a second image were stored in a control unit of the ink jet printer.

Then, marketed glossy sheets (photography sheet <glossy> manufactured by Seiko Epson Co., Ltd.) were set in the printer.

In the first mode, a value of duty (%) of the glitter ink shown in the following formula (I) was set to 10%, 20%, 30%, 40%, 50%, and 60%, and an image in each value was formed on the other glossy sheet, thereby forming a print matter.

Duty(%)=number of actually printed dots/(longitudinal resolution×transverse resolution)×100 (1)

(where, “number of actually printed dots” is the number of actually printed dots per unit area, “longitudinal resolution” and “transverse resolution” are resolution per unit area)

In the second mode, a value of duty (%) of the glitter ink was set from 10% to 60%, each first image was formed, then each value of duty (%) of the clear ink of each first image was set to 10%, and the second image was formed, thereby forming a print matter. The result is shown in Table 1. Similarly, the first image was formed in which the value of duty (%) of the glitter ink was 30%, 40%, 50%, and 60%, the value of duty (%) of the clear ink was set to 30%, and the second image was formed, thereby forming a print matter. The result is shown in Table 2.

### [4] Assessment of Gas Resistance

As for the print matters according to the examples and the comparative examples, a gloss degree (initial value) was measured at a tilt angle of 60° using a gloss degree meter (MINOLTA MULTI GLOSS 268).

Thereafter, the print matters of the examples and the comparative examples were exposed to ozone at a temperature of 23.0° C. for 2 hours, a humidity of 50% RH, and an ozone concentration of 40 ppm, using “Ozone Weather Meter OMS-H type” (product name, manufactured by Suga Test Instruments Co., Ltd.).

The gloss degrees of the print matters at the tilt angle of 60° before and after the ozone exposure were measured.

The result is shown in Table 1 and Table 2.

TABLE 1

Descent Rate [%]

| | | Clear Ink |
|---|---|---|
| Duty of Glitter Ink | Only Glitter Ink | Duty 10% |
| 10% | 31.14 | 16.28 |
| 20% | 30.45 | 13.62 |
| 30% | 27.96 | 11.52 |
| 40% | 26.03 | 9.79 |
| 50% | 24.28 | 8.87 |
| 60% | 24.19 | 8.42 |

TABLE 2

| | Descent Rate [%] |
|---|---|
| Duty of Glitter Ink | Clear Ink Duty 30% |
| 30% | 4.38 |
| 40% | 4.26 |
| 50% | 4.22 |
| 60% | 3.8 |

As seen from Table 1 and Table 2, in the print matter formed in the second mode in which the clear ink is overlapped, the gas resistance is improved. Similarly, since the first mode and the second mode are provided, the user appropriately selects a mode, and it is possible to obtain the print matter having the image with desired image quality. In addition, when the duty of the glitter ink is improved, a descent rate can be lowered (third mode and fourth mode).

What is claimed is:

1. An ink jet printing apparatus which prints an image on a printing medium using glitter ink with dispersed glitter pigment and clear ink which does not substantially include a color material,
wherein the ink jet printing apparatus has a first mode of ejecting substantially only the glitter ink to the printing medium to form the image, and a second mode having a process of ejecting the glitter ink to the printing medium to form a first image by an ink jet method and a process of ejecting clear ink onto the first image by the ink jet method to form a second image, to form the image formed of the first image and the second image, and
wherein a mode is selected from the first mode and the second mode to print the image on the printing medium.

2. The ink jet printing apparatus according to claim 1, wherein a third mode of ejecting a larger amount of glitter ink per unit area than that in the first mode to the printing medium to form the image by the ink jet method is provided in addition to the first mode and the second mode, and
wherein a mode is selected from the first mode, the second mode, and the third mode to print the image on the printing medium.

3. The ink jet printing apparatus according to claim 1, wherein a fourth mode having a process of ejecting the glitter ink to the printing medium to form a first image by the ink jet method and a process of ejecting clear ink onto the first image by the ink jet method to form a second image is provided to form the image formed of the first image and the second image in addition to the first mode and the second mode, and in the fourth mode, a larger amount of glitter ink per unit area than that in the second mode to the printing medium is ejected to form the image, and
wherein a mode is selected from the first mode, the second mode, and the fourth mode to print the image on the printing medium.

4. The ink jet printing apparatus according to claim 1, further comprising a control unit that receives an instruction of a user,
wherein a mode is selected from the first mode and the second mode on the basis of the instruction received by the control unit.

5. The ink jet printing apparatus according to claim 1, wherein the glitter pigment included in the glitter ink is silver particles.

6. The ink jet printing apparatus according to claim 1, wherein the amount of ejected glitter ink per unit area in the second mode is smaller than the amount of ejected glitter ink per unit area in the first mode.

7. The ink jet printing apparatus according to claim 1, wherein the glitter ink contains water at 50 mass % or more.

8. An ink jet printing method of printing an image on a printing medium using glitter ink with dispersed glitter pigment and clear ink which does not substantially include a color material,
wherein the ink jet printing method includes a first mode of ejecting substantially only the glitter ink to the printing medium to form the image by an ink jet method, and a second mode having a process of ejecting the glitter ink to the printing medium to form a first image by an ink jet method and a process of ejecting clear ink onto the first image by the ink jet method to form a second image, to form the image formed of the first image and the second image, and
wherein a mode is selected from the first mode and the second mode to print the image on the printing medium.
